(19) United States
(12) Patent Application Publication
(10) Pub. No.: US 2012/0197991 A1
(43) Pub. Date: Aug. 2, 2012

(54) METHOD AND SYSTEM FOR INTUITIVE INTERACTION OVER A NETWORK

(75) Inventors: Srinivasan Ramani, Bangalore (IN); Sriganesh Madhvanath, Bangalore (IN); Anbumani Subramanian, Bangalore (IN)

(73) Assignee: Hewlett-Packard Development Company, L.P., Houston, TX (US)

(21) Appl. No.: 13/338,960

(22) Filed: Dec. 28, 2011

(30) Foreign Application Priority Data
Jan. 28, 2011 (IN) 262/CHE/2011

(51) Int. Cl. G06F 15/16

(52) U.S. Cl. 709/204

(57) ABSTRACT

Intuitive interaction may be performed over a network. The interaction may include collection of feedback from participants, wherein the feedback is active, passive, or a combination of both. The feedback from the participants may be aggregated and the aggregated feedback can be provided to at least one participant or a non-participant.

### BACKGROUND

Technology has created new vistas for people to interact. Gone are the days when one had to travel miles to meet someone. People can now literally sit in any part of the world and connect to each other using one or the other technology networks. Whether it is voice, over a cellular network, or data transfer over a computer network, getting in touch with another person is just a few clicks away.

Realizing the need and importance of virtual interaction, companies are coming out with novel and interesting solutions to bring people together.

Also, with people preferring more personalized interaction, simple text based e-mail and chat programs are becoming passé, and the world is increasingly moving towards more interactive modes of communication, such as, video chats and video conferencing. However, even aforementioned means has certain limitations.

### BRIEF DESCRIPTION OF THE DRAWINGS

For a better understanding of the solution, embodiments will now be described, purely by way of example, with reference to the accompanying drawings, in which:

FIG. 1 shows a flow chart of a computer-implemented method of intuitive interaction over a network according to an embodiment.

FIG. 2 shows a top level view of an implementation of the method of FIG. 1 over a network according to an embodiment.

FIG. 3A shows a top level view of an interface used to implement an embodiment of the solution on a participant's system.

FIG. 3B shows a top level view of an interface used to implement an embodiment of the solution on another participant's system.

FIG. 4 shows a block diagram of a computing system according to an embodiment.

### DETAILED DESCRIPTION OF THE INVENTION

Personalized virtual interaction like video conferencing is increasingly being used to accomplish a variety of tasks, such as conducting a virtual meeting. However, as mentioned earlier, even this mode has certain limitations. To provide an example, let's assume that a virtual meeting is being conducted where a presenter is giving a presentation to multiple participants (viewers) spread over various geographic locations and connected over a network, for example, a VPN (virtual private network). Under this scenario, if the presenter wants to obtain feedback from his/her audience on a topic under discussion, then some of options probably available to him/her would be to elicit a show of hands, or to poll each participant individually. It is not difficult to realize that this mechanism may not be appropriate in a number of situations, not counting the difficulty the presenter would face in counting the number of hands that might go up in response to a query or the time that might get wasted in individual polling.

There are presently no solutions available that could obtain feedback from a multiple number of participants, in a virtual environment, in a convenient and unobtrusive way.

The proposed solution provides a mechanism that supports natural interaction with a device and enables intuitive feedback from participants in a virtual interaction environment. Embodiments of the present solution provide a method, system and computer executable code for intuitive interaction over a network.

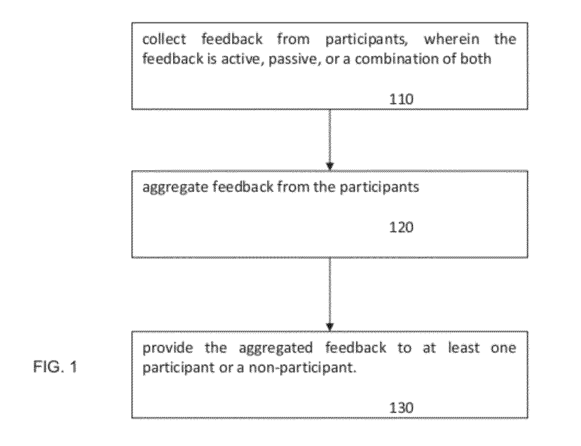

FIG. 1 shows a flow chart of a computer-implemented method of intuitive interaction over a network according to an embodiment.

The method may be implemented on a variety of networks. For example, the method may be implemented on one of the following networks in isolation or in combination with another network(s).
(a) a computer network;
(b) a satellite network;
(c) a cellular network;
(d) a public switched telephone network (PSTN)
(e) a Digital Subscriber Line (DSL) network;
(f) a television network.

Also, a computer network may be a private network, such as an intranet, or a public network, such as, the Internet. Further, the method may be implemented using a cloud computing architecture.

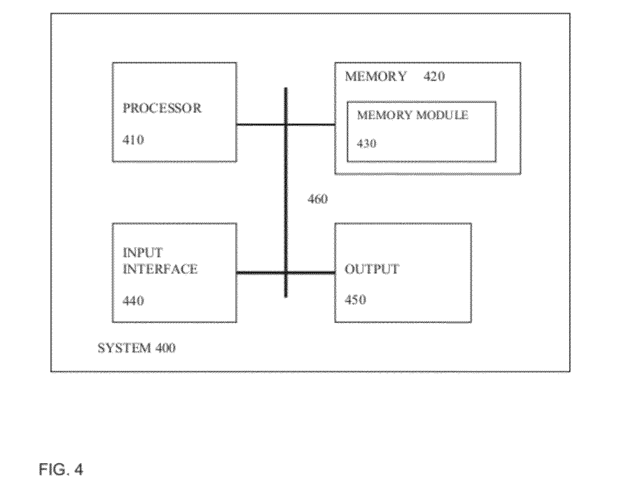

In an embodiment, it is assumed that there are a multiple participants connected together over a network for a virtual interaction. The participants may use a computing device, such as, but not limited to, a personal computer, a desktop computer, a laptop computer, a notebook computer, a network computer, a personal digital assistant (PDA), a mobile device, a hand-held device, or any other suitable computing device. A typical computing device used by a participant is described further in detail subsequently with reference to FIG. 4.

The method step 110 involves collecting feedback from participants, wherein the feedback may be an active feedback, a passive feedback, or a combination of both. To illustrate, we provide a non-limiting example of a virtual classroom environment. In a virtual classroom setting, typically, there would be at least one presenter (teacher) and a multiple number of participants (students) connected together over a network, such as, the Internet. It may be noted that the presenter (say, a teacher) is a “participant” in the context of a virtual meeting (interaction) of this nature, where he or she is interacting with other “participants” (say, students).

Typically in prior solutions, other participants may not have an option to give feedback to the presenter. Alternatively, participants may have to sit in a posture suitable for operating a computer, laptop or other computing device and take special care to communicate feedback at appropriate moments. Ideally, participants should be free to sit in any position they can see a display screen, such as a TV screen and be as relaxed as they like. In the present embodiment, however, the participants can use gestures to communicate their responses intuitively and naturally without too much effort and without consciously operating a computer in a continuous manner. They can also provide feedback unconsciously through body language, such as glancing away from the screen, walking away from it, yawning, etc. The method will therefore collect both active and/or passive feedback in a manner that is more convenient to the participant.

The method collects active (explicit) feedback from participants by capturing and recognizing hand gestures of participants, speech inputs of participants, lip movements of participants, etc.

To provide some non-limiting illustrations, the method recognizes active hand gestures of participants, such as head, hand and finger movements for “yes”, “no”, “I don't know”, applause, pause, start, ‘go slow’, ‘go fast’, ‘not clear’, ‘that's OK’, etc. A large variety of hand gestures are recognizable.

In addition, gesture vocabulary is also customizable by a user (participant) by adding his/her own gesture with its associated meaning.

Hand or figure gestures provide an unobtrusive way for a participant to provide his/her feedback, such as, showing approval or disapproval of a statement, argument or point of view.

In another embodiment, gestures may also be used to communicate commands to a computing device such as: ‘print the currently displayed document’, ‘switch off’, “I am pointing to my answer” (for example a, b, c, or d of a multiple-choice question). The method may also recognize a gesture indicating that the participant wants to ask a question, or to make a comment, such that it is audible to all participants and presenters.

The method also recognizes facial gestures such as smile, frown, an affirmative nod or a negative shaking of the head.

The method may further recognize speech inputs from participants(s). The participant may use short utterances to supplement or to substitute other gestures (such as visual gestures). For example, a participant may use words like “yes”, “no”, to answer simple questions, and use spoken sounds such as “a”, “b”, “c” or “d” to answer multiple choice questions. The participant may also use short utterances such as “right”, “got it”, “I don't get it”, “go faster”, “slow down”, “repeat that”, “question”, etc.

In addition to recognition of active gestures, the method further collects passive (implicit) feedback from participants by tracking gaze of participants, facial gestures of participants, posture changes of participants, etc.

For example, the method may monitor head-pose and eye gaze to determine what the user is looking at (device screen or some other object). Passive facial gestures of participants such as a yawn, frown, confused expression, shaking of the head, scratching of the forehead, etc. may also be captured. In addition, any posture changes of a participant suggesting restlessness or lack of interest in the group activity may be recognized as well. Feedback on these points, aggregated over a whole group, would be of value to the presenters, indicating where they lose listeners' attention.

The recognition of above mentioned gestures and other inputs from a participant provides both explicit and implicit feedback to another participant such as a presenter in a virtual classroom environment. The feedback may be of the type such as but not limited to, attentiveness of a participant, a request from a participant, object of attention of a participant, a query from a participant, etc.

In another embodiment, the above method may be employed in a virtual meeting environment as well. Slightly different from the classroom setup described above, the meeting may involve an office environment, where a manager (a participant) might share some data or information with his colleagues (other participants) over a VPN (virtual private network).

A still another embodiment envisages an interaction over a television network. In this setting, a multiple number of participants might be viewing a video or other media through a television (TV). For example, a family could be viewing a program on a home TV. In such scenario, the embodiment envisages collecting feedback from participants (viewers). The feedback may be an active feedback (through mechanisms described above) or a passive feedback (again, as described earlier). To illustrate, let us assume that the family has watched a number of programs over a certain period of time. In such a case, the method would capture the family members' response (active and passive reactions) related to program content of each televised program telecast during given time periods. As mentioned earlier, these responses (feedback) may be in the form of hand gestures, speech inputs, gaze movements, etc.

Step 120 involves aggregation of the feedback from the participants. In this step, the feedback collected from the participants whether active, passive or both, is aggregated or combined together. In addition, various responses (feedbacks) from a participant may be combined together. To illustrate, if a participant raises his hand to ask a query and also supplements it with a short utterance to attract attention, both responses (hand gesture and speech input) may be combined together to generate a request to the presenter.

In another embodiment, a specific gesture feedback of all participants may be combined. For example, the gaze movement of all participants may be combined to estimate the attention level of the participants (such as to analyze how many participants are looking at their device=50%, 70% or 90%, etc). In another example, the hand gesture of all participants may be combined to arrive at the number of raised hands to a polled question (reported as 20%, 40% or 60%, etc.).

Step 130 involves providing the aggregated feedback to at least one participant or to a non-participant. Both explicit (active request) and implicit (passive status) feedback (responses) from a participant in a virtual interaction is provided to at least one another participant or a non-participant. Feedback from multiple participants may also be simultaneously provided to at least one another participant or a non-participant. The step is illustrated below in the context of earlier mentioned examples.

In the virtual classroom scenario, various aggregated responses (feedbacks) from a participant may be presented to the presenter (teacher). To illustrate, if a participant is waiving his/her hand and also supplementing it with a short utterance to attract attention (for instance to convey that he/she is unable to hear the presenter's voice), both responses (hand gesture and speech input) would be presented as request to the presenter. By extension, if a multiple number of participants are facing a similar problem, their responses may be presented either on individual basis or a combined response may be generated (indicating for instance that 70% of participants are unable to hear the presenter) and presented to the presenter on his/her computing device.

To provide another illustration in the virtual classroom scenario, the aggregated feedback on the attention level of a participant or participants (students) may be presented to a presenter (teacher). The aggregated feedback related to the attention level of a participant(s) is determined by capturing and combining a participant(s) implicit response (for example, changes in gaze movement, posture, facial expressions, etc). A presenter would be able to view attention level details of an individual participant and also for all participants grouped together (for example, in the form of a percentage for the group as a whole).

In the virtual meeting scenario, a manager (presenter) may be presented aggregated feedback related to his colleagues (other participants) during the meeting. For example, queries originating from other participants, their attentiveness level, requests pending etc.

In the television viewing scenario, where multiple participants might view a program on a television (TV), the feedback (both active and passive reactions) collected from participants (viewers), related to program content of each televised program, may be aggregated and presented to a non-participant. A non-participant for the present purposes could be a person(s) or an entity who may not be an active participant during an interaction of such nature (TV viewing). For example, a TV channel could be a non-participant, a third-party rating agency could also be a non-participant, or for that matter any individual who might be interested in participants (viewers) reaction (feedback) to the content played on the television. Also, in another scenario, the feedback to different segments of a recorded and played back presentation, viewed through a network or otherwise, may be collected and used for immediate decision making, or recorded for later analysis.

Once an aggregated feedback related to a participant(s) has been provided to another participant(s) or non-participant(s), the participant (or non-participant) may use the aggregated feedback to provide a response to other participants. For example, in the virtual classroom scenario, the teacher (presenter) based on the received feedback may alter his/her presentation (for example, lesson details) to the students (participants) involved in the interaction. In another case, the teacher may take a poll of the participants, and based on the aggregated feedback may decide to postpone a future lecture or modify the lecture plan. Numerous kinds of responses are possible.

Also, a participant or a non-participant may provide a response immediately or at a later point in time.

Further, the aggregation of feedback from the participants may include analyzing a segment or the sum total of feedback from all the participants; and, based on the analysis, a participant or a non-participant may provide a response to other participants.

In another scenario, the aggregated feedback to at least one participant or a non-participant may be provided in the form of a summary.

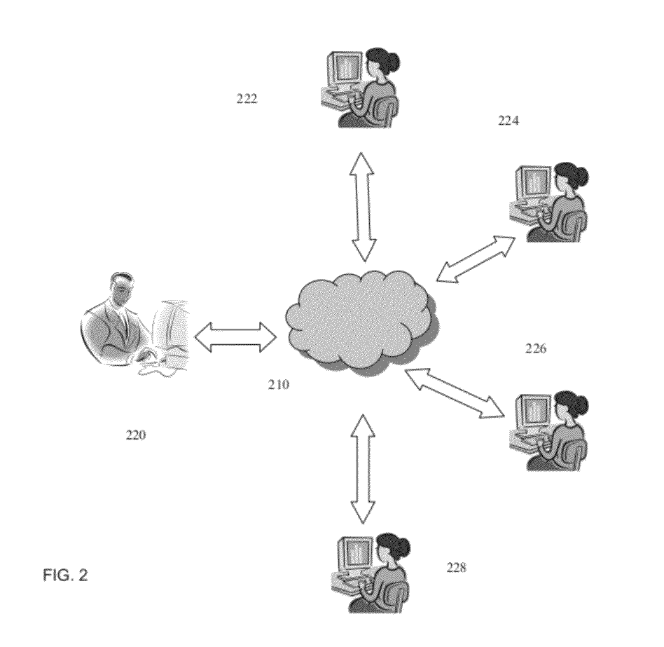

FIG. 2 shows a top level view of an implementation of the method of FIG. 1 over a network according to an embodiment.

The system 200 of FIG. 2 includes multiple participants 220, 222, 224, 226, 228 connected to each other over a network 210.

As mentioned earlier, the method may be implemented on a variety of networks. For example, a computer network (such as, an intranet or the Internet), a satellite network, a cellular network, a television network, etc.

Also, a participant 220, 222, 224, 226, 228 may connect to the network 210 using a computing device, such as, but not limited to, a personal computer, a desktop computer, a personal digital assistant (PDA), a mobile device, a hand-held device, etc.

In the present example, a teacher (participant) is connected to other participants 220, 222, 224, 226, 228 over a network 210 for a virtual interaction. The network 210 may be a wired or a wireless network.

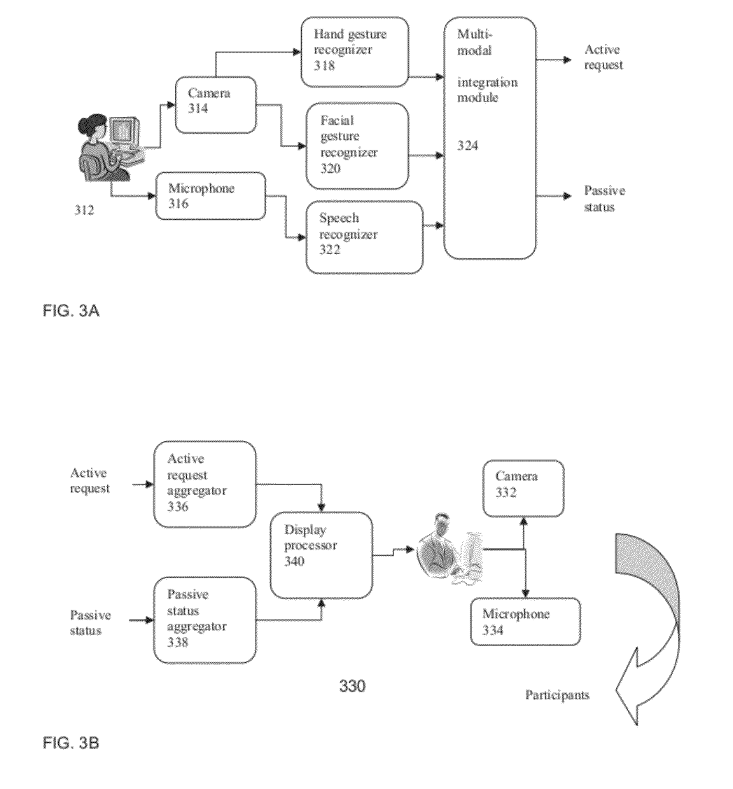

FIG. 3A shows a top level view of an interface used to implement an embodiment of the solution on a participant's system.

The interface 310 includes a participant's system 312 connected to a network (not shown) for a virtual interaction with other participants (not shown), a camera 314, a microphone 316, a hand gesture recognizer 318, a facial gesture recognizer 320, a speech recognizer 322 and a multi-modal integration module 324.

A participant connected to other participant's over a network provides his/her feedback related to an interaction on the network through his/her system 312. The system includes a camera 314 to capture various gestures (hand gesture, facial gesture, etc.) of the participant. It also includes a microphone 316 to capture audio inputs of the participant. The gestures and audio inputs of the participant are recognized and analyzed by respective analyzers: hand gesture recognizer 318, facial gesture recognizer 320 and speech recognizer 322. The recognized gestures and audio inputs of the participants are combined by the multi-modal integration module 324 to generate an active request(s) and a passive status of the participant. The active request(s) and the passive status of the participant are subsequently provided to another participant or a non-participant. This is illustrated in FIG. 3B.

FIG. 3B shows a top level view of an interface used to implement an embodiment of the solution on another participant's system.

The active request(s) and the passive status of the participant (as illustrated in FIG. 3A) are provided to another participant or a non-participant. For example, in FIG. 3B, the “another participant” may be a presenter in a virtual interaction. In such case, the presenter's interface 330, on his/her system, may include a camera 332, a microphone 334, an active request (feedback) aggregator 336, a passive status (feedback) aggregator 338, and a display processor 340.

As mentioned above, the active request(s) and the passive status of a participant or multiple participants are provided to another participant, a presenter, in this example. The active request (feedback) aggregator 336 combines the active feedback of participants and the passive status (feedback) aggregator 338 combines the passive feedback of participants. Once aggregated, the display processor 340 provides a combined feedback to the presenter's system, who would use it to modify his communication to other participants through video (captured by camera 332) and/or speech (picked up by microphone 334).

FIG. 4 shows a block diagram of a computing system according to an embodiment.

The system 400 may be a computing device, such as, but not limited to, a personal computer, a desktop computer, a laptop computer, a notebook computer, a network computer, a personal digital assistant (PDA), a mobile device, a hand-held device. Further, the system 400 may be a standalone system or a network system (such as, but not limited to, a client/server architecture) connected to other computing devices through wired or wireless means.

In addition, the system may be a TV receiver or TV set-top box.

The system 400 may include a processor 410, for executing machine readable instructions, a memory 420, for storing machine readable instructions (such as, a memory module 430), an input interface 440 and an output device 450. These components may be coupled together through a system bus 460.

The processor 410 is arranged to execute machine readable instructions. The machine readable instructions may comprise a module for aggregating the feedback collected from participants, and to provide the aggregated feedback to at least one participant or a non-participant.

The memory 420 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 420 stores a module 430.

The input interface 440 may include at least one of the following: a camera, a mouse, a key pad, a touch pad, a touch screen, a microphone, a gesture recognizer, a speech recognizer, a gaze recognizer, a lip movement recognizer, and the like. The interface 440 collects feedback from participants. The feedback may be active, passive, or a combination of both.

The output device 450 may include a Virtual Display Unit (VDU), a printer, a scanner, and the like, for displaying aggregated feedback of inputs received through the input interface 440.

It would be appreciated that the system components depicted in FIG. 4 are for the purpose of illustration only and the actual components may vary depending on the computing system and architecture deployed for implementation of the present solution. The various components described above may be hosted on a single computing system or multiple computer systems, including servers, connected together through suitable means.

The embodiments described provide an efficient mechanism to conduct an intuitive virtual interaction involving multiple participants by recognizing participant feedback through non-obtrusive modes (such as, gestures) and also enables providing a response to the aggregated feedback. The mechanisms makes it possible to summarize the responses of a number of participants or TV viewers and to present a summarized feedback.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present solution.

1. A computer-implemented method of intuitive interaction over a network, comprising:
collecting feedback from participants, wherein the feedback is active, passive, or a combination of both;
aggregating, by a processor, the feedback from the participants; and
providing the aggregated feedback to at least one participant or a non-participant.

2. A method according to claim 1, wherein collecting feedback from participants includes recognition of at least one of the following: a hand gesture of a participant, a facial gesture of a participant, gaze movement of a participant, a speech input from a participant or a lip movement of a participant, presence and identity of the participant.

3. A method according to claim 1, wherein the at least one participant or a non-participant uses the aggregated feedback to provide a response to other participants.

4. A method according to claim 1, wherein aggregating the feedback from the participants includes analyzing a segment or entire interaction amongst the participants.

5. A method according to claim 4, wherein the analysis is used by a participant or a non-participant to provide a response to other participants.

6. A method according to claim 1, wherein the feedback includes at least one of the following: attentiveness of a participant, a request from a participant, object of attention of a participant or a query from a participant.

7. A method according to claim 1, wherein the aggregated feedback to at least one participant or a non-participant is provided in the form of a summary.

8. A method according to claim 1, wherein the network is from one of the following: a computer network, a satellite network, a cellular network, public switched telephone network (PSTN), Digital Subscriber Line (DSL) or a television network.

9. A system, comprising:
an interface to collect feedback from participants, wherein the feedback is active, passive, or a combination of both;
a memory to store machine readable instructions; and
a processor to execute the machine readable instructions, the machine readable instructions comprising:
a module to aggregate the feedback collected from the participants, and to provide the aggregated feedback to at least one participant or a non-participant.

10. A system according to claim 9, wherein the feedback collection from participants includes recognition of at least one of the following: a hand gesture of a participant, a facial gesture of a participant, gaze movement of a participant, a speech input from a participant or a lip movement of a participant, presence and identity of the participant.

11. A system according to claim 9, wherein the interface includes a camera along with at least one of the following: a gesture recognizer, a gaze recognizer and/or a lip movement recognizer.

12. A system according to claim 9, wherein the interface includes a microphone along with a speech recognizer.

13. A system according to claim 9, wherein the at least one participant or a non-participant uses the aggregated feedback to provide a response to other participants.

14. A system according to claim 9, wherein the feedback to different segments of a recorded and played back presentation, viewed through a network or otherwise, is collected and used for immediate decision making, or recorded for later analysis.

15. A non-transitory computer readable medium comprising computer readable instructions which are executable by a processor, the instructions comprising:
collect feedback from participants, wherein the feedback is active, passive, or a combination of both;
aggregate the feedback from the participants; and
provide the aggregated feedback to at least one participant or a non-participant.
